(19) United States
(12) Patent Application Publication
(10) Pub. No.: US 2009/0205020 A1
(43) Pub. Date: Aug. 13, 2009

(54) INFORMATION PROCESSING APPARATUS, INFORMATION PROCESSING SYSTEM, INFORMATION PROCESSING METHOD AND COMPUTER READABLE MEDIUM

(75) Inventors: Yuji KAZAMA, Kawasaki-shi (JP); Yoichi HIROSE, Kawasaki-shi (JP); Noriaki SUZUKI, Kawasaki-shi (JP); Toru IZUMIYA, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/198,160

(22) Filed: Aug. 26, 2008

(30) Foreign Application Priority Data
Feb. 7, 2008 (JP) 2008-027309

(51) Int. Cl. G06F 21/00

(52) U.S. Cl. 726/4

(57) ABSTRACT

An information processing apparatus includes a first setting section, and a second setting section. The first setting section sets, when a first user is in a first status which indicates the first user moves out from a first group, a first authority under which the first user is permitted to read out and prohibited to write into the first electronic information. The first setting section sets, when a second user is in a second status which indicates the second user moves into a second group, a second authority under which the second user is permitted to read out and prohibited to write into the second electronic information. The second setting section cancels, when the first user satisfies a first condition, the first authority. The second setting section changes, when the second user satisfies a second condition, the second authority into an authority based on the second group.

### CROSS-REFERENCE TO RELATED APPLICATIONS

This application is based on and claims priority under 35 USC 119 from Japanese Patent Application No. 2008-027309 filed Feb. 7, 2008.

### BACKGROUND

1. Technical Field

The present invention relates to an information processing apparatus, an information processing system, an information processing method and a computer readable medium.

2. Related Art

In order to manage electronic information stored in a computer system securely, setting of an access authority is performed.

### SUMMARY

According to an aspect of the invention, a computer readable medium storing a program causing a computer to execute a process for controlling access authorities, the process includes: setting, when a first user is in a first status which indicates the first user moves out from a first group, a first authority under which the first user is permitted to read out first electronic information and is prohibited to write into the first electronic information; setting, when a second user is in a second status which indicates the second user moves into a second group, a second authority under which the second user is permitted to read out second electronic information and is prohibited to write into the second electronic information; canceling, when the first user satisfies a first condition relating to moving out from the first group, the first authority, and changing, when the second user satisfies a second condition relating to moving into the second group, the second authority into an authority based on the second group.

### BRIEF DESCRIPTION OF THE DRAWINGS

Exemplary embodiment(s) of the present invention will be described in detail based on the following figures, wherein:

FIG. 1 is a conceptual module block view on a configuration example of this exemplary embodiment;

FIG. 2 is an explanatory view showing an example of organizational transfer;

FIG. 3 is a explanatory view showing an example of the status of organizational transfer in this exemplary embodiment;

FIG. 4 is a flowchart showing an example of processing in accordance with this exemplary embodiment;

FIG. 5 is a flowchart showing an example of processing of status transition upon organizational transfer in accordance with this exemplary embodiment;

FIG. 6 is a flowchart showing an example of processing of status transition upon an elapse of time period in accordance with this exemplary embodiment;

FIG. 7 is an explanatory view showing an example of display of a document list screen in accordance with this exemplary embodiment;

FIG. 8 is an explanatory view showing an example of display of an operation list screen in accordance with this exemplary embodiment;

FIG. 9 is an explanatory view showing an example of display of an operation list screen in accordance with this exemplary embodiment;

FIG. 10 is an explanatory view showing an example of the data structure of a status access authority table;

FIG. 11 is an explanatory view showing an example of the data structure of the user status table;

FIG. 12 is an explanatory view showing an example of the data structure of a personnel DB change content list table;

FIG. 13 is an explanatory view showing an example of the data structure of the original organization information table;

FIG. 14 is an explanatory view showing an example of the data structure of the destination organization information table;

FIG. 15 is an explanatory view showing an example of the data structure of the organization information table;

FIG. 16 is an explanatory view showing an example of the data structure of the organization information table;

FIG. 17 is an explanatory view showing an example of the data structure of the status policy (default authority) table of a group A;

FIG. 18 is an explanatory view showing an example of the data structure of the status policy (transition rule) table of the group A;

FIG. 19 is a block diagram showing an example of the configuration of the whole system; and

FIG. 20 is a block diagram showing an example of the configuration of a computer hardware for implementing this exemplary embodiment.

### DETAILED DESCRIPTION

Below, an example of one exemplary embodiment for implementing the present invention will be described by reference to the accompanying drawings.

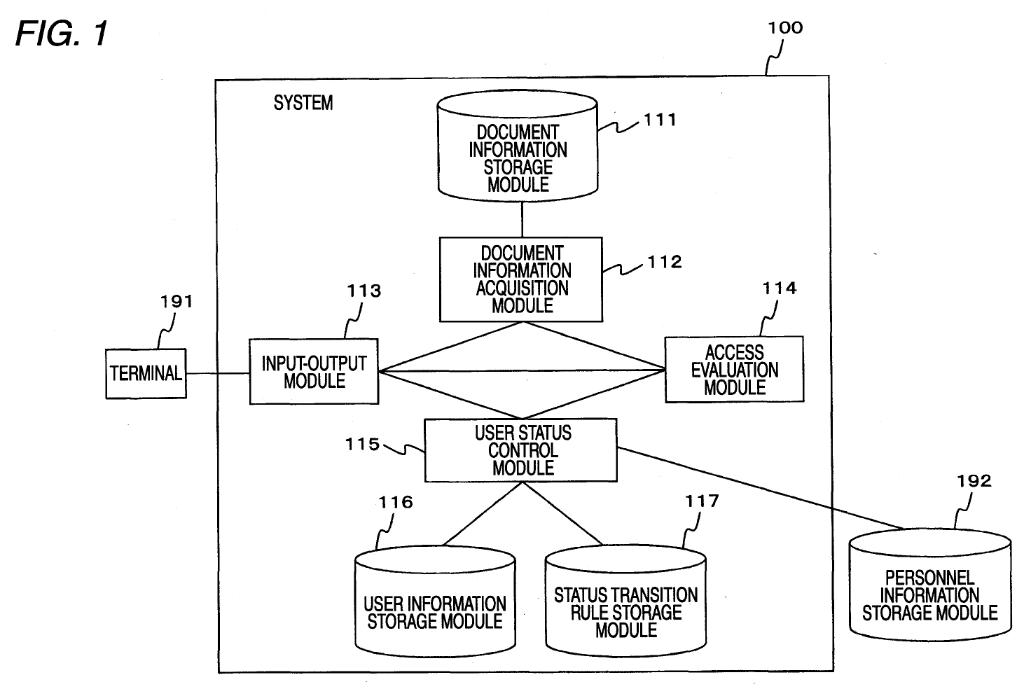

FIG. 1 shows a conceptual module block diagram regarding a configuration example of this exemplary embodiment.

Incidentally, the module denotes commonly logically separable software (computer/program), or a component such as hardware. Therefore, the module in this exemplary embodiment denotes not only the module in computer/program but also the module in a hardware configuration. For this reason, this exemplary embodiment also covers the description of the computer/program, system, and method. However, for convenience of description, wordings “storing”, and “being stored”, and the wordings equal to these are used. However, these wordings mean “causing a storage device to store” or “control a storage device to store” when the exemplary embodiment is a computer/program. Further, each module correspond to one function, roughly one to one. However, in packaging, one module may be formed of one program, or a plurality of modules may be formed of one program. Reversely, one module may be formed of a plurality of programs. Further, a plurality of modules may be executed by one computer. Alternatively, one module may be executed by a plurality of computers by computers in a discrete or parallel environment. Incidentally, one module may include other modules. Further, the term “connection” is also used not only for the physical connection but also for the logical connection (such as giving and receiving of data, instruction, or reference relation between data).

Further, a system or an apparatus includes a plurality of computers, hardware, devices, and the like connected to one another by a communication section such as a network (including one-to-one correspondence communication connection). In addition, it includes the case where the system or apparatus is implemented by one computer, hardware, device, or the like. The terms “apparatus” and “system” are used as the mutually synonymous words.

Below, a description will be given by mainly exemplifying a document as electronic information. Incidentally, the document is a text, or, in some cases, electronic data such as images, moving images, or sounds, a unit of named structures, which can undergo storing, edit, search, and the like, and which can be exchanged as individual units between systems or users. The documents include the ones similar to these. For example, specifically, the document corresponds to the document, electronic mail, or the like, formed by document edit software.

Whereas, a description will be given by mainly exemplifying a group as the mass. As the authority, an access authority is exemplified. The term “access” denotes reading or writing of electronic information with respect to a storage device (including a memory, or the like, but not necessarily the one within the computer). Whereas, the term “access authority” denotes the authority to the operations of reading, writing, deletion, and the like with respect to electronic information. Then, the access authority is the authority of a user to electronic information, and it is set between the two.

This exemplary embodiment has, as with the module configuration example shown in FIG. 1, a system 100, a terminal 191, and a personnel information storage module 192.

The system 100 has a document information storage module 111, a document information acquisition module 112, an input-output module 113, an access evaluation module 114, a user status control module 115, a user information storage module 116, and a status transition rule storage module 117. The whole system 100 is a document management system capable of operations of registration, search, deletion or the like of a document.

Incidentally, the first authority setting section or the second authority setting section includes, for example, the document information acquisition module 112, the access evaluation module 114, and the user status control module 115 shown in FIG. 1. The description regarding the correspondence is the illustration of the subordinate concept of the first authority setting section or the second authority setting section, and it only indicates the correspondence in the example of this exemplary embodiment.

The terminal 191 is connected to the input-output module 113 of the system 100. It issues an operation request to the system 100, and receives the result from the system 100, and outputs the result. The connection with the system 100 may be established by a communication line such as the Internet. For example, specifically, the terminal 191 may be a terminal including a Web browser or the like mounted therein.

The personnel information storage module 192 is connected to the user status control module 115 of the system 100. The personnel information storage module 192 stores information indicating what user belong to what group, and personnel information such as transfer information of a user between groups. The connection with the system 100 may also be established by a communication line as with the terminal 191.

The input-output module 113 is connected to the document information acquisition module 112, the access evaluation module 114, the user status control module 115, and the terminal 191. The input-output module 113 receives a processing request according to the operation of a user operating the terminal 191, and performs an operation of returning the processing results from the document information acquisition module 112, the access evaluation module 114, and the user status control module 115 to the terminal 191. In the description of this exemplary embodiment, in response to the document operation list instruction from the terminal 191, it offers the results of the access evaluation, i.e., the available operation list to the terminal 191.

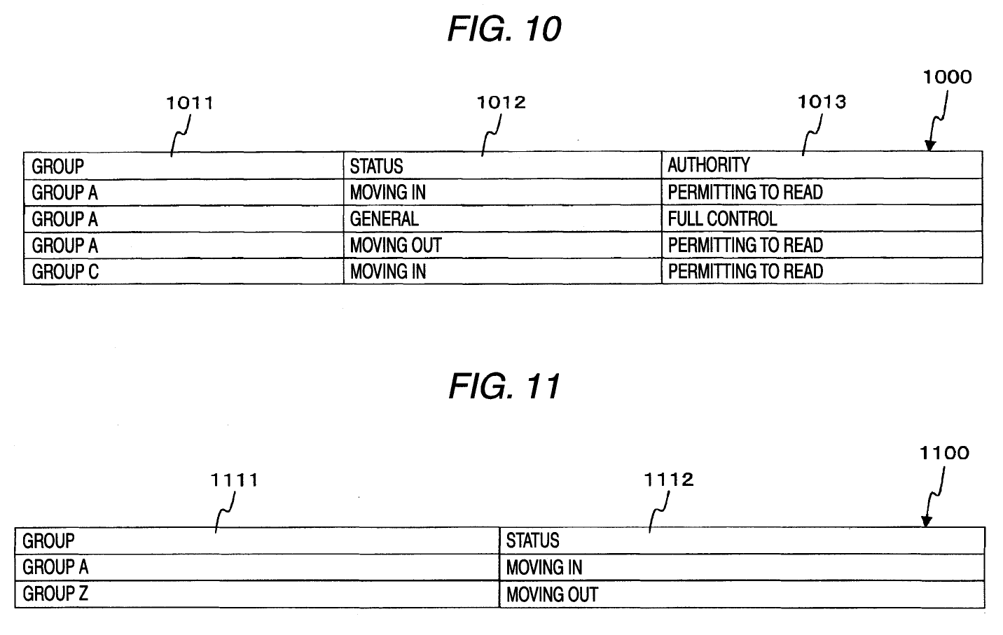

The document information storage module 111 is accessed by the document information acquisition module 112, and stores the attribute information and the content information of the document managed by the system 100. The document information storage module 111 stores a “status access authority” as the document access authority. Data of status access authority is data for defining access according to the status of the operating user, and has the data structure of a status access authority table 1000 shown as an example in FIG. 10.

With reference to FIG. 10, the data structure example of the status access authority table 1000 will be described. The status access authority table 1000 has a group column 1011, a status column 1012, and an authority column 1013. Each row defines the authority of every status of the group. The group column 1011 stores the group to which the user belongs. The status column 1012 stores the belonging status of any user for the group. The authority column 1013 stores the authority when a user is in the status stored in the status column 1012 for the group stored in the group column 1011. For example, the first row represents that “when a user is in the moving in status to the group A, an authority indicating a permitting to read is given to the user”. The second row represents that “when a user is in a general status in the group A, an authority indicating a full control is given to the user”. The third row represents that “when a user is in the moving out status from the group A, an authority indicating a permission to read out is given to the user”. Incidentally, the statuses include four statuses of “moving in”, “general”, “moving out”, and “deletion”, with respect to the group. The status of “moving in” denotes the status until a condition A (a period having elapsed, approval of the boss, or the like) is satisfied after determination of moving in to the group. The status of “general” denotes the status after the moving in status and the condition A is satisfied, i.e., the status in which the user belongs to the group. Thus, the general status denotes the status which is neither the moving in status nor the moving out status. The status of “moving out” denotes the status until a condition B (a period having elapsed, permission of the boss, or the like) is satisfied after determination of the transfer from the group. The status of “deletion” denotes the status after the moving out status and the condition B is satisfied, i.e., the status in which the user does not belong to the group. Incidentally, the moving in status, the general status, and the moving out status will be described later by reference to FIG. 3.

Whereas, the authority of the permission to read out denotes the authority of enabling read of the target document. In other words, when a user is in a moving out status in relation to the case where the user moves out from a group, an authority under which the user is permitted to read out and prohibited to writing into is set with respect to the document on to which the group has an authority. When the user is in a moving in status in relation to the case where the user moves into a group, an authority which the user is permitted to read out and prohibited to writing into is set with respect to the document on to which the group has an authority.

The document information acquisition module 112 is connected to the document information storage module 111, the input-output module 113, and the access evaluation module 114. The document information acquisition module 112 accesses the document information storage module 111, and acquires document information. In response to a request from the input-output module 113 or the access evaluation module 114, it sets and acquires a “status access authority” with respect to the document. Then, it passes the acquired document information to the input-output module 113 or the access evaluation module 114.

The access evaluation module 114 is connected to the document information acquisition module 112, the input-output module 113, and the user status control module 115, and it performs access evaluation on the document. Thus, it performs access evaluation on the document based on the “status access authority” acquired by the document information acquisition module 112 and the “transfer status” acquired by the user status control module 115. In other words, when a user is in a moving out status in the case where the user moves out from a group, an access authority under which the user is permitted to read out and prohibited to writing into is set with respect to the document on which the group has an authority. Whereas, when a user is in a moving in status in the case where the user moves into a group, an access authority under which the user is permitted to read out and prohibited to writing into is set with respect to the documents on which the group has an authority. Then, when the user satisfies a condition A, the access authority to the document with the authority based on the moving out status set thereto is canceled (i.e., as a specific example, the user is prohibited to access the document of the original group). Whereas, when the user satisfies a condition B, the access authority to the document with the authority based on the moving in status set thereto is set to the access authority based on the group into which the user has moved (i.e., as a specific example, the access authority as a group member of the destination group).

Further, the access evaluation module 114 may be configured not to cover the document registered after the access authority based on the moving out status is set as the object of setting of the access authority based on the first status.

Whereas, when no one except for the above user has an access authority to write into the document to which the access authority to write is to be set until the condition B is satisfied, the access evaluation module 114 may be configured to set an access authority based on the moving in status to the document. In other words, this is performed in order to prevent the state that no one can perform writing on the document.

The user status control module 115 is connected to the input-output module 113, the access evaluation module 114, the user information storage module 116, the status transition rule storage module 117, and the personnel information storage module 192. Thus, the user status control module 115 accesses the user information storage module 116 and the status transition rule storage module 117. The user status control module 115 sets and acquires the “status transition rule” and the “user information”. Further, the user status control module 115 accesses the personnel information storage module 192, and acquires the “transfer status” based on “user identification” and “group” as the keys.

The user information storage module 116 is accessed by the user status control module 115, and stores information concerning the user. For example, specifically, it is the information of what user belongs to what group. It stores the “transfer status” of the user for every group.

Herein, the term “transfer status” will be described.

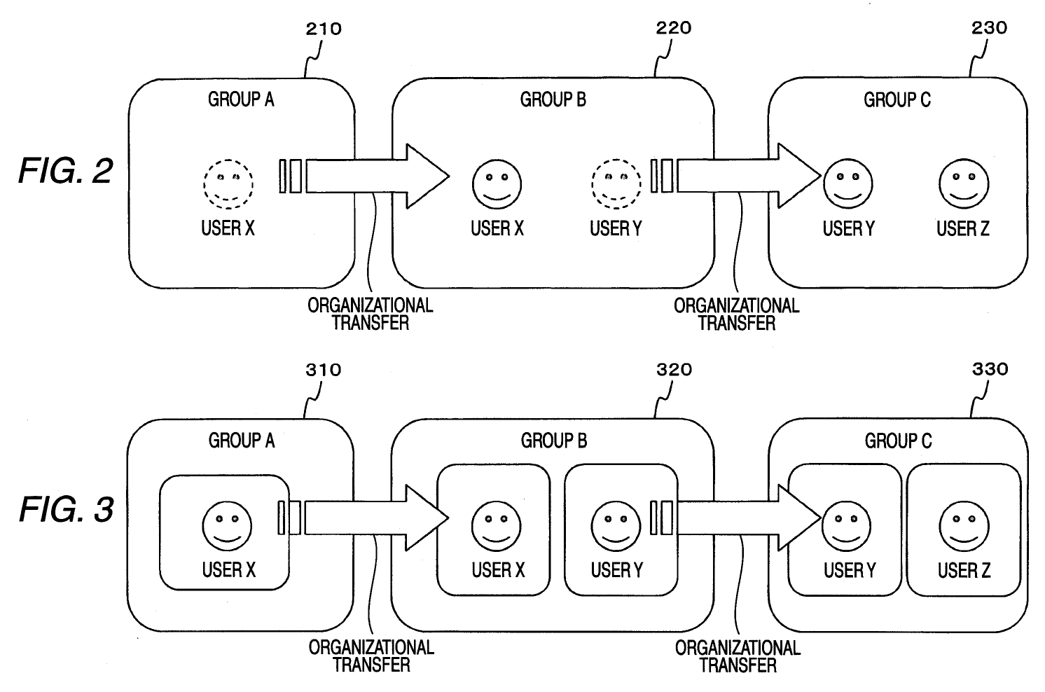

FIG. 2 is an explanatory view showing an example of the organizational transfer. FIG. 3 is an explanatory view of a status example of the organizational transfer in this exemplary embodiment.

At first, a user X belonged to a group A210, a user Y belonged to a group B220, and a user Z belonged to a group C230. According to organizational transfer, the user X transferred from the group A210 to the group B220; and the user Y, from the group B220 to the group C230. In this case, when the access authority is changed according to the transfer, taking over charge associated with the transfer and the like may interfere with work. In other words, this is due to the following fact. The user X had a certain access authority to the document on which the group A210 had an authority before transfer. However, after transfer, the user X becomes completely incapable of accessing to the document. Similarly, when the user X has a certain access authority to the document to which the group B220 has an authority, the user is enabled to perform rewriting and the like to the document in an inexperienced manner after transfer.

The transfer status is the concept as shown in an example of FIG. 3. In other words, when the user X transfers from the group A310 to the group B320 by the organizational transfer, the user X is not deleted from the original group A310, and given the status of “moving out”. Whereas, similarly, when the user Y transfers from the group B320 to the group C330, the user Y is given the status of “moving in” at the destination group C330. Thus, the user Y can be discriminated from the user Z who has already belonged to the group C330. Incidentally, the user Z is in a “general” status.

The status transition storage module 117 is accessed by the user status control module 115, and stores the rule for causing transition of the status of the user. The following transition rule can be set.

“Personnel announcement” is a rule that when the group to which a user belongs is changed in the personnel database stored in the personnel information storage module 192, the transfer user undergoes transition into another status. The details thereof will be described later.

“Time” is a rule that transition into another status is caused upon an elapse of a given time. The details thereof will be described later.

“Approval” is a rule that when a boss who is a supervisor of the user approves, the user undergoes transition into another status.

“History/frequency” is a rule that a certain value is calculated from the operation history or the operation frequency of the user, and the user undergoes transition into another status based on the value.

“Administrator” is a rule that the user undergoes transition into another status by the manual operation of a system administrator.

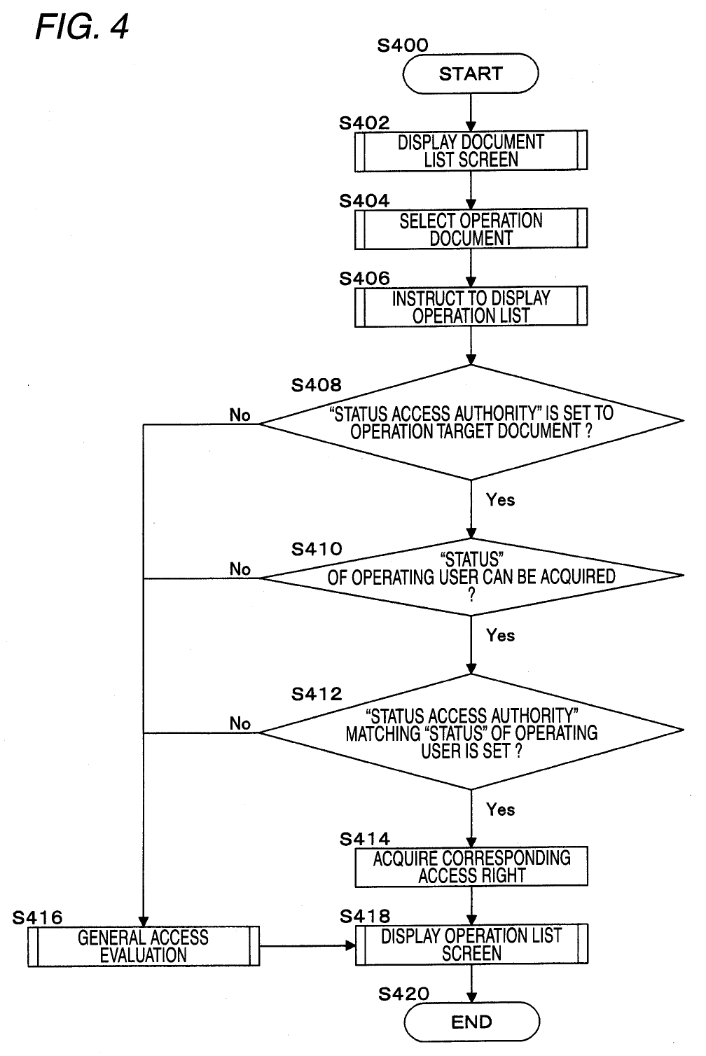

FIG. 4 is a flowchart showing an example of processing in accordance with this exemplary embodiment.

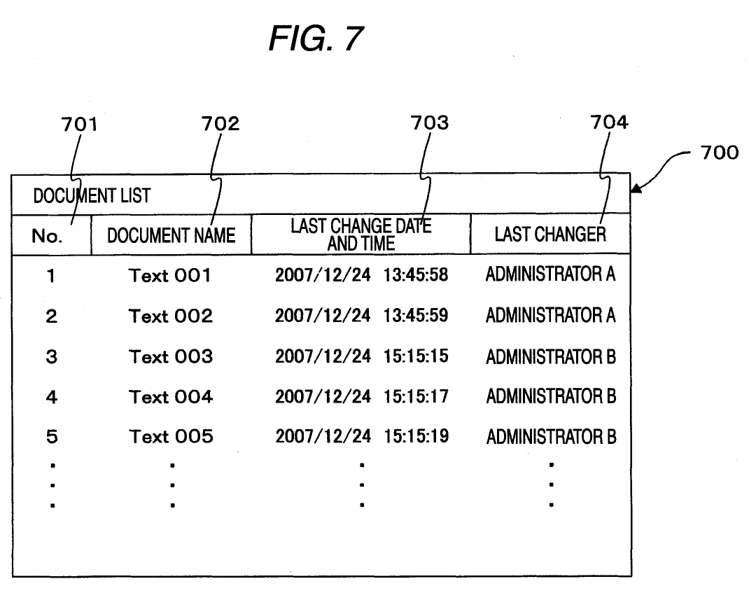

In a step S402, the document information acquisition module 112 of the system 100 displays a document list screen to the terminal 191 via the input-output module 113. The displayed document list screen is, for example, as shown in FIG. 7. In other words, a document list screen 700 has a No. column 701, a document name column 702, a last change date and time column 703, a last changer column 704, and the like. In other words, for every document, the last change date and time column 703, the last changer column 704, and the like, which are the attribute information, are shown.

In a step S404, in response to the operation of a user, the terminal 191 selects a document targeted for operation in the document list screen.

In a step S406, in response to the operation of a user, the terminal 191 instructs to display operation list of the document targeted for operation. Then, the input-output module 113 receives the selected document and the directed operation list to be displayed, and passes the selected document and the directed operation list to be displayed to the document information acquisition module 112.

In a step S408, the document information acquisition module 112 checks whether the “status access authority” can be acquired or not. In other words, the document information acquisition module 112 accesses the document information storage module 111, and judges whether the status access authority in the status access authority table 1000 concerning the user can be acquired, or not. When the status access authority cannot be acquired (in the case of No), the process proceeds to a step S416. When the status access authority can be acquired (in the case of Yes), the acquired status access authority is holed on a memory and the process proceeds to a step S410.

In the step S410, the user status control module 115 checks whether acquire the “user status” can be acquired or not. In other words, the user status control module 115 accesses the user information storage module 116, and judges whether the “user status” concerning the user can be acquired, or not. When the user status cannot be acquired (in the case of No), the process proceeds to the step S416. When the user status can be acquired (in the case of Yes), the acquired user status information is holed on a memory, and the process proceeds to a step S412.

Incidentally, the user status information stored in the user information storage module 116 is configured as an example of the data structure of a user status table 1100 shown as an example of FIG. 11. In other words, the user status table 1100 has a group column 1111 and a status column 1112. The status of the group stored in the group column 1111 is stored in the status column 1112. The example shown in FIG. 11 shows the state in which the user is moving out of the group Z and moving into the group A.

In the step S412, the access evaluation module 114 checks whether the “status access authority” matching the “user status” is set or not. In other words, the access evaluation module 114 judges whether the “user status” obtained from the user status control module 115 and the “status access authority” obtained from the document information acquisition module 112 correspond to each other, or not. When not corresponding to each other (in the case of No), the process proceeds to the step S416. When there is a correspondence therebetween (in the case of Yes), the process proceeds a step S414.

In the step S414, the access authority is acquired from the corresponding setting at the step S412.

In the step S416, the access evaluation module 114 performs general access evaluation (which is the access evaluation in a general status, for example, the evaluation by the access authority list in general document management).

In a step S418, the access evaluation module 114 displays the screen of a list of possible operations from the access authority acquired and evaluated at the step S414 or the step S416 to the terminal 191, and completes the processing (step S420).

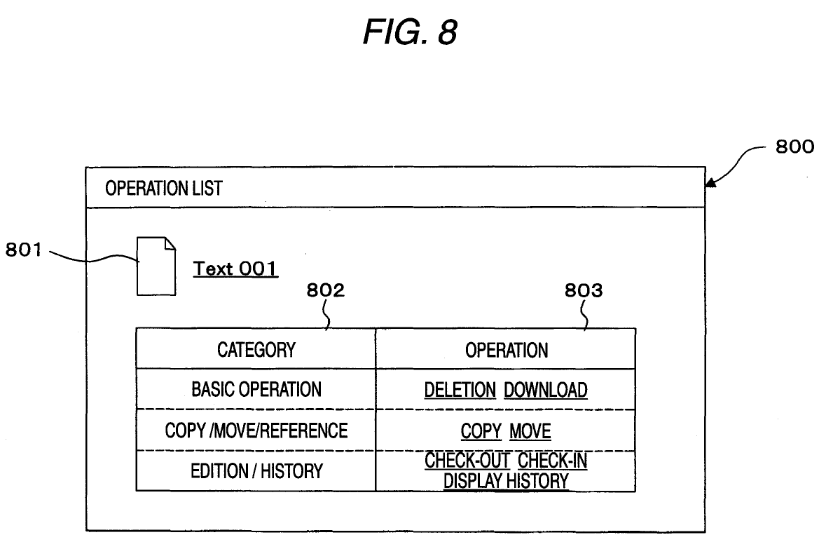

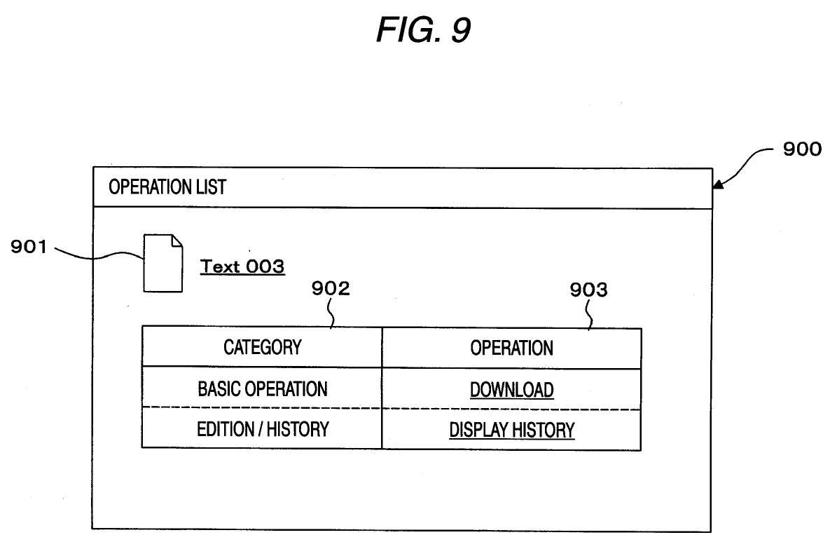

The operation list screens are, for example, those shown in FIGS. 8 and 9.

An operation list screen 800 shown as an example of FIG. 8 has a Text001 801, and a category column 802 and an operation column 803, corresponding thereto. The operation list screen 800 shows an example of full control as the authority. It shows that the target user can perform deletion, downloading, copy, moving, check-out, check-in, and history display as shown in the operation column 803 on the Text001 801.

Whereas, an operation list screen 900 shown in FIG. 9 has a Text003 901, and a category column 902 and an operation column 903, corresponding thereto. The operation list screen 900 shows an example of downloading which is one of reading authority, and history display as authority. It is shown that the target user can perform downloading, and history display as shown in the operation column 903 on the Text003 901. Incidentally, downloading means reading out.

As an example of the status transition rule, the processing flow regarding the “personnel announcement” and the “time” will be described.

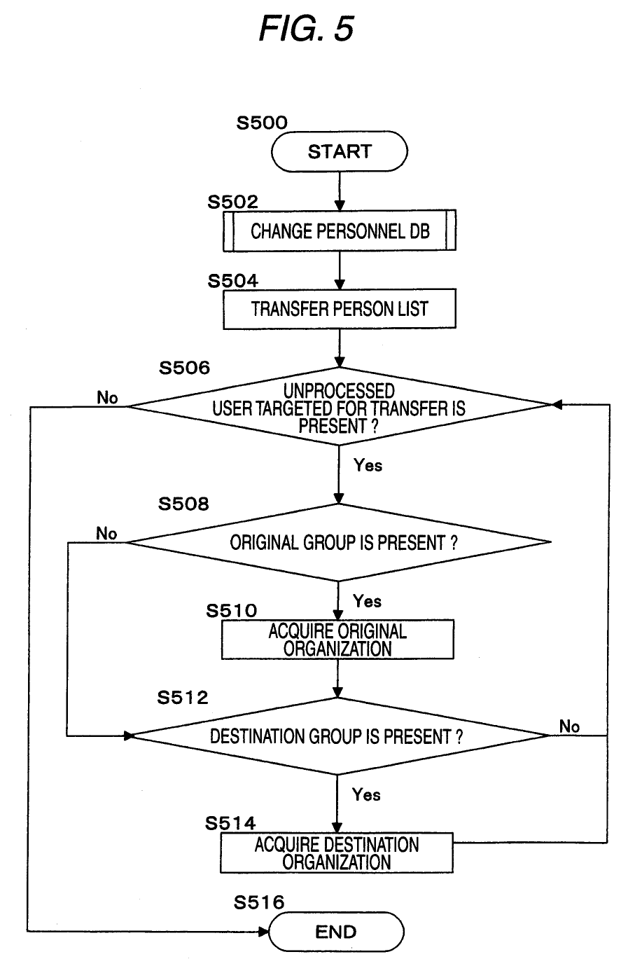

FIG. 5 is a flowchart showing an example of processing of status transition at the time of organizational transfer in accordance with this exemplary embodiment, and an example of processing regarding the status transition by “personnel announcement”. Herein, an original organization information table 1300 shown as an example of FIG. 13 and a destination organization information table 1400 shown as an example of FIG. 14 will be completed.

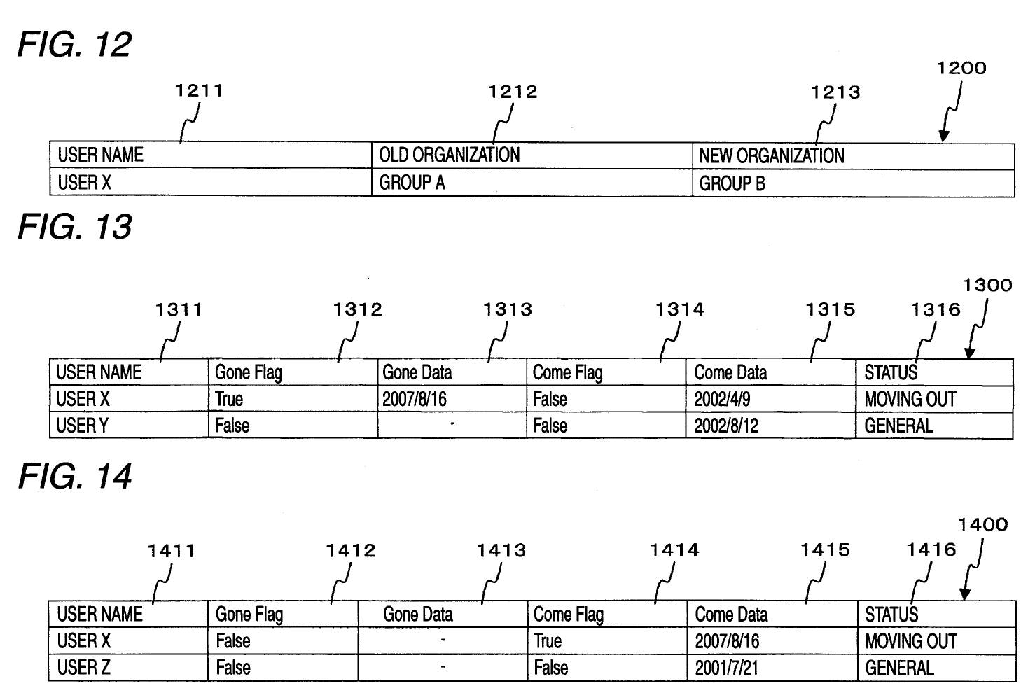

In a step 502, in response to the operation by the personnel information administrator, the organizations to which the personnel transfer persons belong in the personnel information storage module 192 are changed. Then, the list of transfer persons is transmitted to the user status control module 115 of the system 100. Incidentally, the list of transfer persons is configured as, for example, an example of a personnel DB change content list table 1200 shown in FIG. 12. In other words, the personnel DB change content list table 1200 has a user name column 1211, an old organization column 1212, and a new organization column 1213. The user name column 1211 stores the persons targeted for transfer; the old organization column 121, the old organizations (original groups) of the target persons; and the new organization column 1213, the new organizations (destination groups) of the target persons. The example shown in FIG. 12 shows that a user X of the user name column 1211 transfers from the group A of the old organization column 1212 to the group B of the new organization column 1213.

In a step S504, the user status control module 115 acquires the list of transfer persons in the personnel information storage module 192.

In a step S506, the user status control module 115 checks whether unprocessed users targeted for transfer are present or not. In other words, when unprocessed users targeted for transfer are present (in the case of Yes), one unprocessed user targeted for transfer is selected. Then, the process proceeds to a step S508. When no unprocessed user is present (in the case of No), the process is completed (step S516).

In the step S508, the user status control module 115 accesses the user information storage module 116. Then, the user status control module 115 checks whether information of the original organization in which the user targeted for transfer has been present can be acquired or not. In other words, when the information of the original organization can be acquired (in the case of Yes), the process proceeds to a step S510. When the information can be acquired (in the case of No), the process proceeds a step S512.

In the step S510, the user status control module 115 acquires information of the original organization. Incidentally, the information of the original organization is configured as the example of an original organization information table 1300 shown in FIG. 13. The original organization information table 1300 has a user name column 1311, a Gone flag column 1312, a Gone Date column 1313, a Come flag column 1314, a Come Date column 1315, and a status column 1316. The user name column 1311 stores the target user. The Gone flag column 1312 stores a flag indicative of whether the user has moved out or not (“True” indicates that the user has moved out, and “False” indicates that the user has not moved out yet). The Gone Date column 1313 stores the date (which may include time, minute, and second) of moving out. The Come flag column 1314 stores a flag indicative of whether the user has moved in or not. The Come Date column 1315 stores the date of moving in. The status column 1316 stores the status of transfer.

Then, the Gone flag column 1312 of the target user is set as True. Further, the Gone Date column 1313 of the user is updated to the current date. The status column 1316 of the user in the original organization is set to “moving out”.

In the step S512, the user status control module 115 accesses the user information storage module 116. Then, the control module 115 checks whether information of the destination organization in which the user targeted for transfer transfers can be acquired or not. In other words, when the information of the destination organization (in the case of Yes) can be acquired, the process proceeds to a step S514. When it cannot acquire the information (in the case of No), the process returns to the step S506.

In the step S514, the user status control module 115 acquires information of the destination organization. Incidentally, the information of the destination organization is configured as the example of a destination organization information table 1400 shown in FIG. 14. The destination organization information table 1400 has the same data structure as that of the original organization information table 1300. It has a user name column 1411, a Gone flag column 1412, a Gone Date column 1413, a Come flag column 1414, a Come Date column 1415, and a status column 1416. The user name column 1411 stores the target user. The Gone flag column 1412 stores a flag indicative of whether the user has moved out or not. The Gone Date column 1413 stores the date of moving out. The Come flag column 1414 stores a flag indicative of whether the user has moved in or not. The Come Date column 1415 stores the date of moving in. The status column 1416 stores the status of transfer.

Then, when target user is not present, another user is newly added to the destination organization information table 1400. The Come flag column 1414 of the user of the destination organization is set as True. Further, the Come Date column 1415 of the user is updated to the current date. The status column 1416 of the user in the destination organization is set at moving in. Then, the process returns to the step S506.

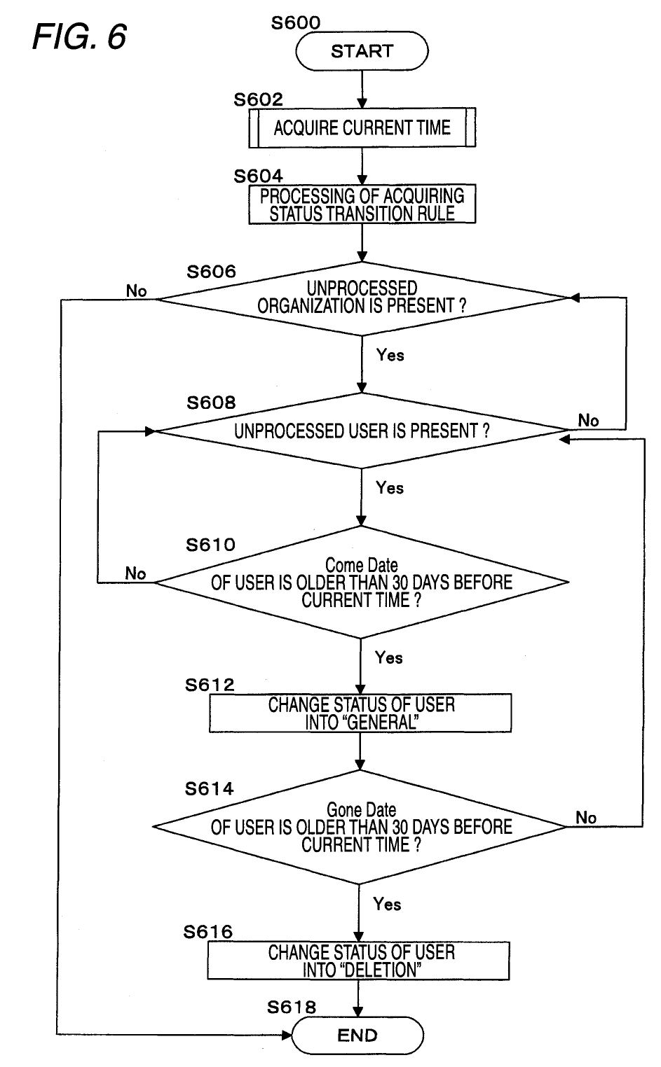

FIG. 6 is a flowchart showing an example of processing of status transition upon elapse of time period in accordance with this exemplary embodiment. It is an example of processing regarding status transition by “time (elapsed period)”.

In a step S602, the user status control module 115 acquires the current time.

In a step S604, the user status control module 115 accesses the status transition rule storage module 117, and acquires the status transition rule. Herein, the rule for causing transition from the “moving in” status to the “general” status is set at “being after an elapse of 30 days from moving in”. Whereas, the rule for causing transition from the “moving out” status to the “deletion” status is also similarly set at “being after an elapse of 30 days from moving out”.

In a step S606, the user status control module 115 checks whether an unprocessed organization is present or not. In other words, when the unprocessed organization is present (in the case of Yes), one unprocessed organization is selected and the process proceeds to a step S608. When no unprocessed organization is present (in the case of No), the process is completed (step S618).

In the step S608, the user status control module 115 checks whether an unprocessed user is present or not. In other words, when the unprocessed user is present (in the case of Yes), one unprocessed user is selected and the process proceeds to a step S610. When no unprocessed user is present (in the case of No), the process returns to the step S606.

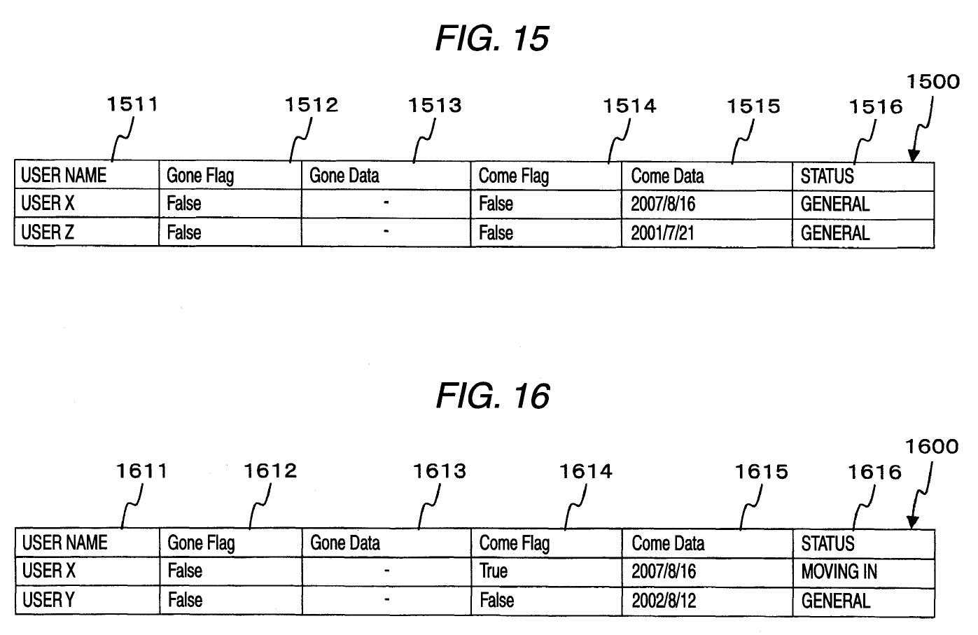

In the step S610, the user status control module 115 checks whether the date of the Come Date column 1515 in an organization information table 1500 (see an example shown in FIG. 15) of the user selected at the step S608 is older than 30 days before the current time acquired at the step S602, or not. In other words, when the date is older (in the case of Yes), the process proceeds to a step S612. When the date is not older (in the case of No), the process returns to the step S608. Incidentally, the data structure of the organization information table 1500 is the same as that of the original organization information table 1300.

In the step S612, the Come flag column 1514 in the user of the organization information table 1500 is set at True. Then, the status column 1516 of the user in the organization is set at “general”.

In a step S614, the user status control module 115 checks whether the date of the Gone Date column 1613 in an organization information table 1600 (see an example shown in FIG. 16) of the user selected at the step S608 is older than 30 days before the current time acquired at the step S602, or not. In other words, when the date is older (in the case of Yes), the process proceeds to a step S616. When the date is not older (in the case of No), the process returns to the step S608. Incidentally, the data structure of the organization information table 1600 is the same as that of the original organization information table 1300.

In the step S616, the user status column 1616 in the organization is set at “delete”. Alternatively, the user in the organization may be deleted from the organization information table 1600.

[Example in which a Status Policy is Set for Each Group]

In the exemplary embodiment described above, one “status access authority” is set for one document. However, the following may also be adopted. The status access authority is not set to a document, and the “status policy” common in a group is set.

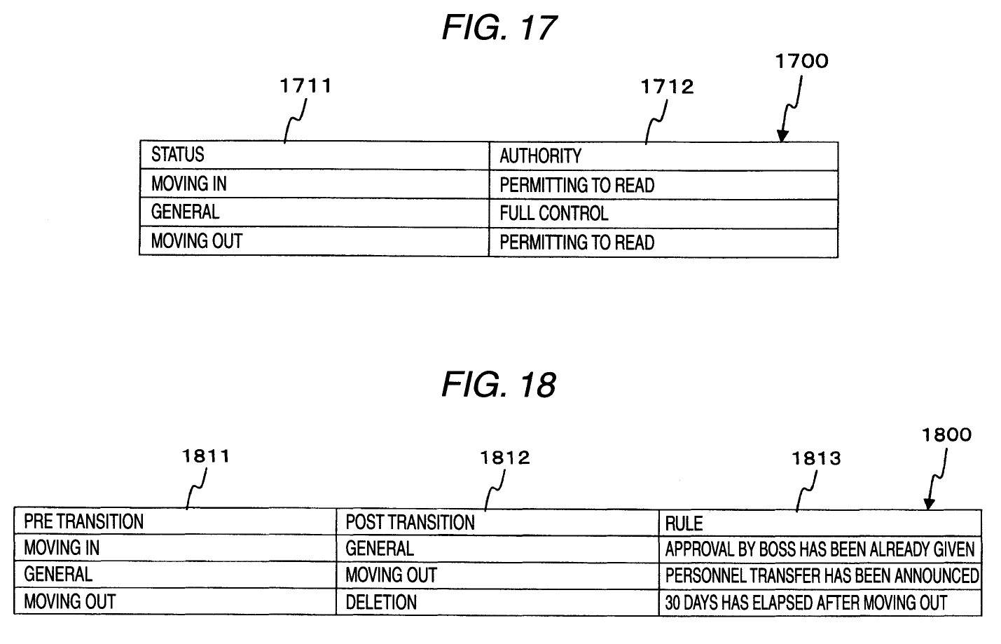

For example, a status policy (default authority) table 1700 of the group A shown in an example of FIG. 17 has a status column 1711 and an authority column 1712. The status column 1711 and the authority column 1712 represent the authority in the case of the status. For example, in the case of a “moving in” status, a “permitting to read” authority is set. In the case of a “general” status, a “full control” authority is set. In the case of a “moving out” status, a “permitting to read” authority is set.

Then, a status policy (transition rule) table 1800 of the group A shown as an example of FIG. 18 has a pre-transition column 1811, a post-transition column 1812, and a rule column 1813. The rule column 1813 represents the rule for changing the status from the pre-transition column 1811 to the post-transition column 1812. For example, the condition (which is a specific example of the prescribed condition A) for transition from the “moving in” status to the “general” status is that “the approval by the boss has been already given”. The condition for transition from the “general” status to the “moving out” status is that a “personnel transfer has been announced”. The condition (which is a specific example of the prescribed condition B) for transition from the “moving out status” to the “deletion status” is that “30 days has elapsed after moving out”.

Alternatively, both of the “status access authority” to the document and the “status policy” as the group may be set. Then, it may be configured such that decide which access authority has priority can be determined when both of them are set.

[Example in which Processing is Performed Based on Time Axis]

In the foregoing exemplary embodiment, the transfer person can access the document which the original organization manages with restrictions. Therefore, the person can similarly access even the document registered after the person has been transferred with restrictions. However, this may inhibit the work. This is because a user who should not be properly present in the organization may know the information of the old organization. In this example, based on the time axis of when the document has been registered, the document registered after transfer is access controlled.

In this example, the step S408 and the step S412 in the flowchart shown in the processing example of FIG. 4 are changed as shown below. Other processings are the same as in the flowchart shown in FIG. 4.

In the step S408, the document information acquisition module 112 checks whether the “status access authority” and the “registered date and time” of the target document can be acquired or not. In other words, the document information acquisition module 112 accesses the document information storage module 111. The document information acquisition module 112 judges whether the status access authority in the status access authority table 1000 regarding the user can be acquired or not. When the status access authority cannot be acquired (in the case of No), the process proceeds to a step S416. When the status access authority can be acquired (in the case of Yes), the acquired status access authority and registered date and time are held on a memory. Then, the process proceeds to a step S410.

In the step S412, the access evaluation module 114 checks whether the “status access authority” matching the “user status” is set or not. In other words, the access evaluation module 114 judges whether the “user status” obtained from the user status control module 115 and the “status access authority” obtained from the document information acquisition module 112 correspond to each other, or not. When “user status” and “status access authority” do not correspond to each other (in the case of No), the process proceeds to the step S416.

When there is a correspondence therebetween (in the case of Yes), further, the access evaluation module 114 holds the set status access authority on a memory, and performs the next processing.

The access evaluation module 114 compares the “Gone Date of the user status (the Gone Date column 1313 of the original organization information table 1300)” with the “registered date and time”. Then, the access evaluation module 114 checks whether the “Gone Date of the user status” is older or not. In other words, when the “Gone Date of the user status” is older, the user is prohibited to access the document (i.e., the status access authority is not set). Then, the warning screen as such is displayed to the terminal 191, and the processing is completed. On the other hand, when the “Gone Date of the user status” is not older, the process proceeds to the step S414.

[Example in which Processing is Performed Based on the Status after Transition of Status]

In the case of transition from the moving in status to the general status, no one may have an access authority to write into a document into which an authority to write is to be set. In that case, the access evaluation module 114 may set a write enable access authority even in the case of the moving in status to the document.

In other words, before setting the status access authority, the access evaluation module 114 previously examines the status after transition using the document information acquisition module 112 and the user status control module 115, and then, sets a status access authority.

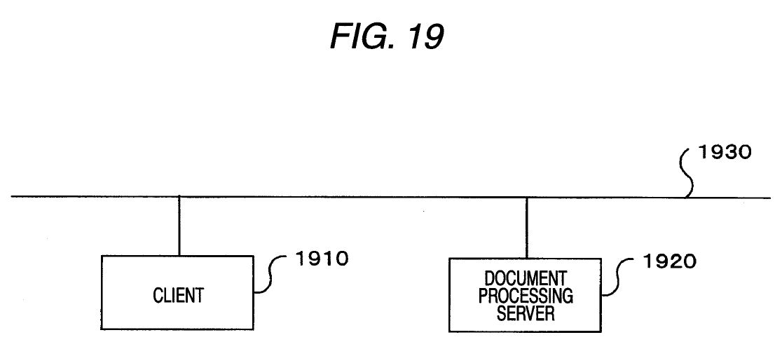

By reference to FIG. 19, a description will be given to an example of a configuration of the whole system for document processing in order to implement this exemplary embodiment.

The whole system includes a client 1910, and a document processing server 1920. The terminal 191 shown in FIG. 1 corresponds to the client 1910. The system 100 corresponds to the document processing server 1920. Incidentally, a plurality of respective configurations may be present. A connection between the client 1910 and the document processing server 1920 is established via a communication line 1920.

The client 1910 has a function of a user interface for an operator to use the document processing server 1920.

For document processing, the document processing server 1920 displays the judgment results of the access authority and the like, and displays the screens (such as the document list screen 700 and the operation list screen 800) for inputting instructions for document processing, and the like to the client 1910.

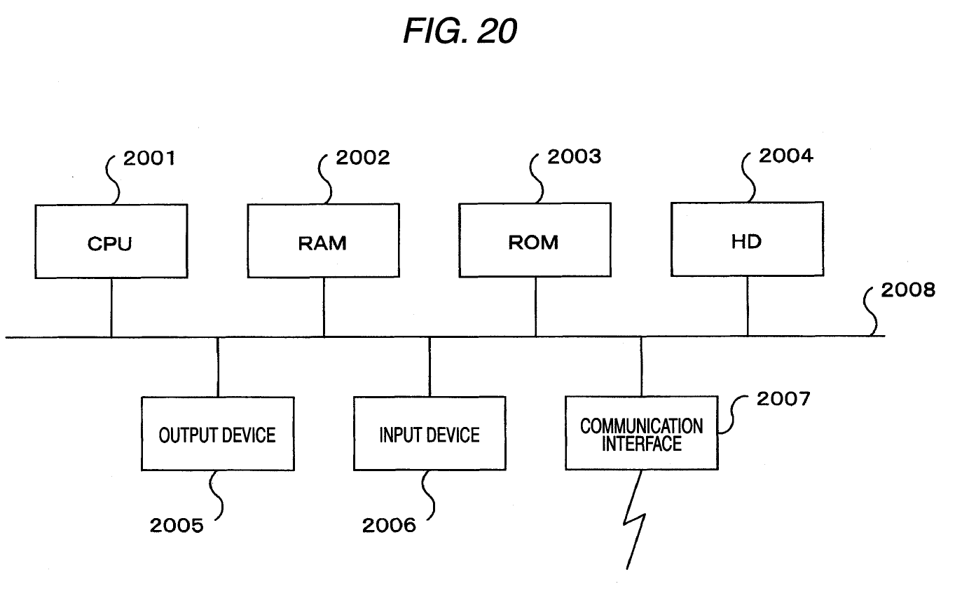

Incidentally, the hardware configuration of a computer whereby the program as this exemplary embodiment is executed is that of a common computer as shown in FIG. 20. Specifically, it is a personal computer, a computer which may be a server, or the like. It includes a CPU 2001 (in this example, a CPU is used as an operation part) for executing a program, including the document information acquisition module 112, the access evaluation module 114, the user status control module 115, and the like; a RAM 2002 for storing the program and data; a ROM 2003 in which a program for starting up the computer, and the like are stored; a HD 2004 which is an auxiliary storage device (for example, a hard disk can be used); an input device 2006 for inputting data such as a keyboard or a mouse; an output device 2005 such as a CRT or a liquid crystal display; a communication interface 2007 (for example, a network interface card can be used) for connection with a communication network; and a bus 2008 for establishing a connection therebetween, and exchanging data. A plurality of the computers may be connected to one another through a network.

As for the exemplary embodiment by a computer/program out of the foregoing exemplary embodiments, the computer/program which is a software is loaded into the system with the hardware configuration. Thus, the software and hardware resources cooperate to implement the exemplary embodiments.

Incidentally, the hardware configuration shown in FIG. 20 shows one configuration example. This exemplary embodiment is not limited to the configuration shown in FIG. 20, and may have any configuration so long as it has a configuration capable of implementing the modules described in this exemplary embodiment. For example, some modules may include special purpose hardware (such as ASIC). Some modules may be in such a form as to be within the external system and to be connected by a communication line. Further, a plurality of the systems shown in FIG. 20 may be connected to one another through a communication line to mutually cooperatively operate. Further, particularly, they may be incorporated into, other than a personal computer, information home appliances, a copier, a facsimile, a scanner, a printer, a multifunction device (an image processing device having any two or more of a scanner, a printer, a copier, a facsimile, and the like), or the like.

Incidentally, the described program may be stored in a recording medium to be provided. Alternatively, the program may be provided by a communication section. In that case, the described program may be seized as the invention of a “computer-readable recording medium having a program recorded thereon”.

The term “computer-readable recording medium having a program recorded thereon” denotes a computer-readable recording medium having a program recorded thereon to be used for installing and executing a program, and distributing a program, and for other purposes.

Incidentally, examples of the recording medium include digital versatile disks (DVDs), such as “DVD-Rs, DVD-RWs, and DVD-RAMs, which are standards formulated in a DVD forum, and such as “DVD+Rs and DVD+RWs, which are standards formulated in DVD+RW, compact disks (CDs), such as read-only memories (CD-ROMs), CD-recordables (CD-Rs), and CD-rewritable's (CD-RWs), magneto-optic disks (MOs), flexible disks (FDs), magnetic tapes, hard disks, read-only memories (ROMs), electrically erasable programmable read-only memories (EEPROMs), flash memories, and random access memories (RAMs).

Further, the above programs or some of them may be stored on the recording media to be saved, distributed, or the like. Further, the programs may be transmitted by communication, for example, using transmission media, such as wired networks, wireless communication networks, or further, combinations thereof, used for local area networks (LANs), metropolitan area networks (MANs), wide area networks (WANs), and the Internet, intranets, extranets, and the like. Alternatively, the programs may also be delivered on a carrier wave.

Furthermore, the programs may be portions of other programs, or may be recorded on the recording media with a separate program. Alternatively, they may be divided and recorded on a plurality of recording media. Further, they may be recorded in any way such as compression or encryption so long as they can be returned to the original program.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for controlling access authorities, the process comprising:
setting, when a first user is in a first status which indicates the first user moves out from a first group, a first authority under which the first user is permitted to read out first electronic information and is prohibited to write into the first electronic information;
setting, when a second user is in a second status which indicates the second user moves into a second group, a second authority under which the second user is permitted to read out second electronic information and is prohibited to write into the second electronic information;
canceling, when the first user satisfies a first condition relating to moving out from the first group, the first authority; and
changing, when the second user satisfies a second condition relating to moving into the second group, the second authority into an authority based on the second group.

2. The computer readable medium according to claim 1, wherein
electronic information registered after the setting of the first authority based on the first status is excluded from a target of the setting of the first authority based on the first status.

3. The computer readable medium according to claim 1, wherein
the setting the second authority includes setting, when no user except for the second user is permitted to write into the second electronic information until the second condition is satisfied, the authority based on the second group as the second authority.

4. An information processing apparatus comprising:
a first setting section that (i) sets, when a first user is in a first status which indicates the first user moves out from a first group, a first authority under which the first user is permitted to read out first electronic information and is prohibited to write into the first electronic information, and (ii) sets, when a second user is in a second status which indicates the second user moves into a second group, a second authority under which the second user is permitted to read out second electronic information and is prohibited to write into the second electronic information; and
a second setting section that (i) cancels, when the first user satisfies a first condition relating to moving out from the first group, the first authority, and (ii) changes, when the second user satisfies a second condition relating to moving into the second group, the second authority into an authority based on the second group.

5. The information processing apparatus according to claim 4, wherein
the first setting section excludes electronic information registered after the setting of the first authority based on the first status from a target of setting of the first authority based on the first status.

6. The information processing apparatus according to claim 4, wherein
the first setting section sets, when no user except for the second user is permitted to write into the second electronic information until the second condition is satisfied, the authority based on the second group as the second authority.

7. An information processing system comprising:
a user status control section that acquires transfer statuses of a user for first and second group, respectively; and
an access evaluation section that (i) sets, when the transfer status acquired by the user status control section is a first status which indicates the user moves out from the first group, a first authority under which the user is permitted to read out first electronic information and is prohibited to write into the first electronic information, and (ii) sets, when the transfer status acquired by the user status control section is a second status which indicates the user moves into the second group, a second authority under which the user is permitted to read out second electronic information and is prohibited to write into the second electronic information,
wherein the access evaluation section (i) cancels, when the user satisfies a first condition relating to moving out from the first group, the first authority and (ii) changes, when the second user satisfies a second condition relating to moving into the second group, the second authority into an authority based on the second group.

8. The information processing system according to claim 7, wherein
the access evaluation section excludes electronic information registered after the setting of the first authority based on the first status from a target of setting of the first authority based on the first status.

9. The information processing system according to claim 7, wherein
the access evaluation section sets, when no user except for the user is permitted to write into the second electronic information until the second condition is satisfied, the authority based on the second group as the second authority.

10. An information processing method comprising:
setting, when a first user is in a first status which indicates the first user moves out from a first group, a first authority under which the first user is permitted to read out first electronic information and is prohibited to write into the first electronic information;
setting, when a second user is in a second status which indicates the second user moves into a second group, a second authority under which the second user is permitted to read out second electronic information and is prohibited to write into the second electronic information;
canceling, when the first user satisfies a first condition relating to moving out from the first group, the first authority; and
changing, when the second user satisfies a second condition relating to moving into the second group, the second authority into an authority based on the second group.

11. The information processing method according to claim 10, wherein
electronic information registered after the setting of the first authority based on the first status is excluded from a target of the setting of the first authority based on the first status.

12. The information processing method according to claim 10, wherein
the setting the second authority includes setting, when no user except for the second user is permitted to write into the second electronic information until the second condition is satisfied, the authority based on the second group as the second authority.
